(19) United States
(12) Patent Application Publication
(10) Pub. No.: US 2010/0317501 A1
(43) Pub. Date: Dec. 16, 2010

(54) Method and device for producing rectangular-bottom bags

(75) Inventor: Giuseppina Taverna, Magnago (MI) (IT)

Correspondence Address: HEDMAN & COSTIGAN, P.C., 1230 AVENUE OF THE AMERICAS, 7th floor, NEW YORK, NY, 10020, US

(73) Assignee: FINSER S.p.A., MAGNAGO (MI) (IT)

(21) Appl. No.: 12/802,493

(22) Filed: Jun. 8, 2010

(30) Foreign Application Priority Data
Jun. 12, 2009 (IT) MI2009A 001049

(51) Int. Cl. B31B 1/00

(52) U.S. Cl. 493/267; 493/186

(57) ABSTRACT

A method for producing rectangular-bottom bags comprising the following steps:

initially making a flat bag (10) with bottom bellows (11);

inserting the flat bag (10) onto a forming group (13) provided with means for widening out (15a, 15b) the bag (10) and making the widening means (15a, 15b) move apart so as to make the flat bag (10) take up a parallelepiped or cube shape;

inserting bellows shaping means (16a, 16b) onto the bag (10), deformed according to the previous step, on side walls or outer sides (P) and a shaping wedge (17) onto the base, and at the same time making said widening means (15a, 15b) come together and inserting the wedge (17);

withdrawing the shaping wedge (17) from the bag (10), once it has been flattened again and thus shaped;

withdrawing the bag (20) formed by the means for widening (15a, 15b) the bag (10).

It also foresees a device for carrying out the aforementioned method.

The present invention refers to a method and to a device for producing rectangular-bottom bags.

In the field of production of bags for containing different kinds of objects, also rectangular or square-bottom bags are required, which are, indeed, quite difficult to produce.

It is indeed the rectangular or square-shaped base that makes the production particularly slow, since, to this day, a method for an automated manufacture has not yet been devised.

The purpose of the present invention is that of making the production of this type of bag as simple as possible.

Another purpose of the present invention is that of providing a method and a device which allow the aforementioned type of bag to be made faster.

These and other purposes according to the present invention are reached by making a method and a device for producing rectangular-bottom bags as outlined in the independent claims.

Further characteristics of the method are object of the dependent claims.

The characteristics and the advantages of a method and of a device for producing rectangular-bottom bags according to the present invention shall become clearer from the following description given as an example and not for limiting purposes, referring to the attached schematic drawings, in which:

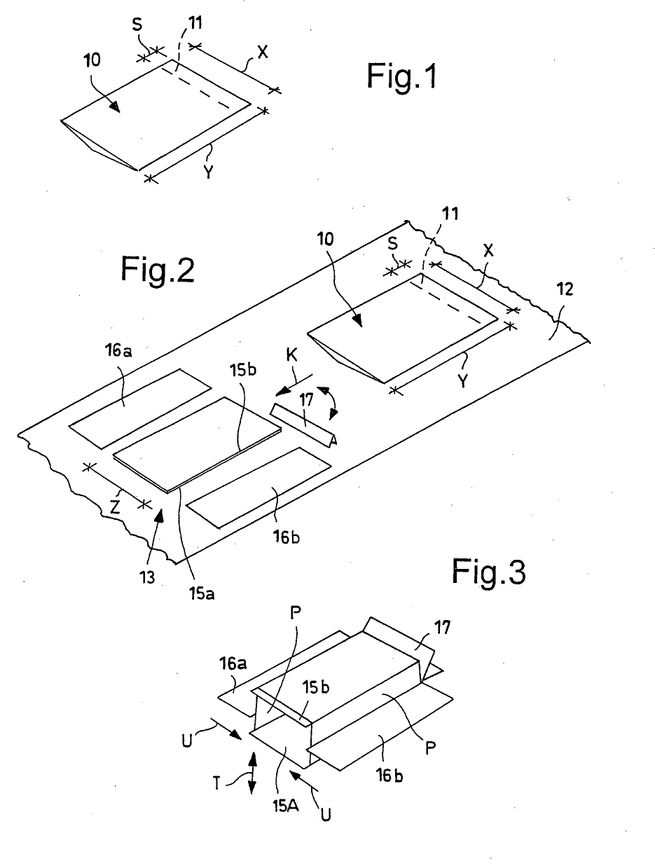

FIG. 1 is a schematic plan view of a first step of the method in which a flat bag is used made in a completely usual way and with certain measurements;

FIG. 2 is a schematic plan view of a second step of the method in which the flat bag of the first step is inserted onto a shaping device according to the invention;

FIG. 3 is a schematic plan view of a third step of the method in which the device is actuated so as to shape the bag previously received;

FIG. 4 is a schematic plan view of a fourth step of the method in which the device is further actuated to continue shaping the bag received;

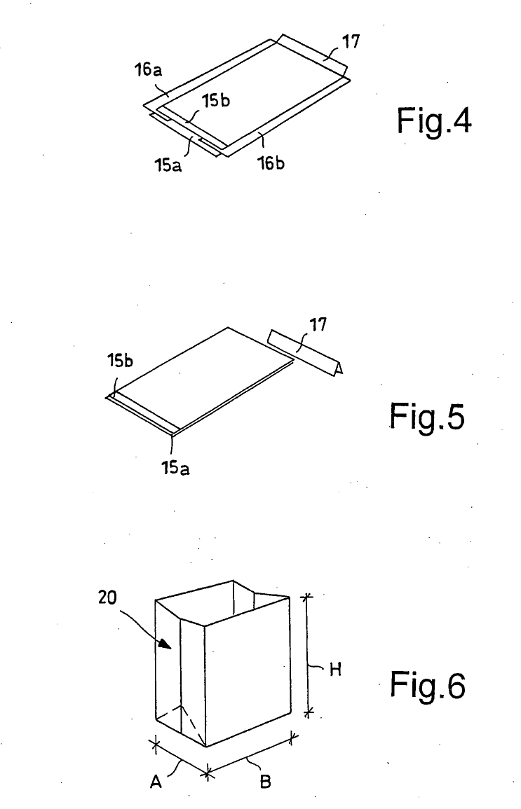

FIG. 5 is a schematic plan view of a fifth and last step of the method in which the bag shaped according to the invention is ready to be withdrawn from the device;

FIG. 6 shows a perspective view of a rectangular-bottomed bag made according to the present invention;

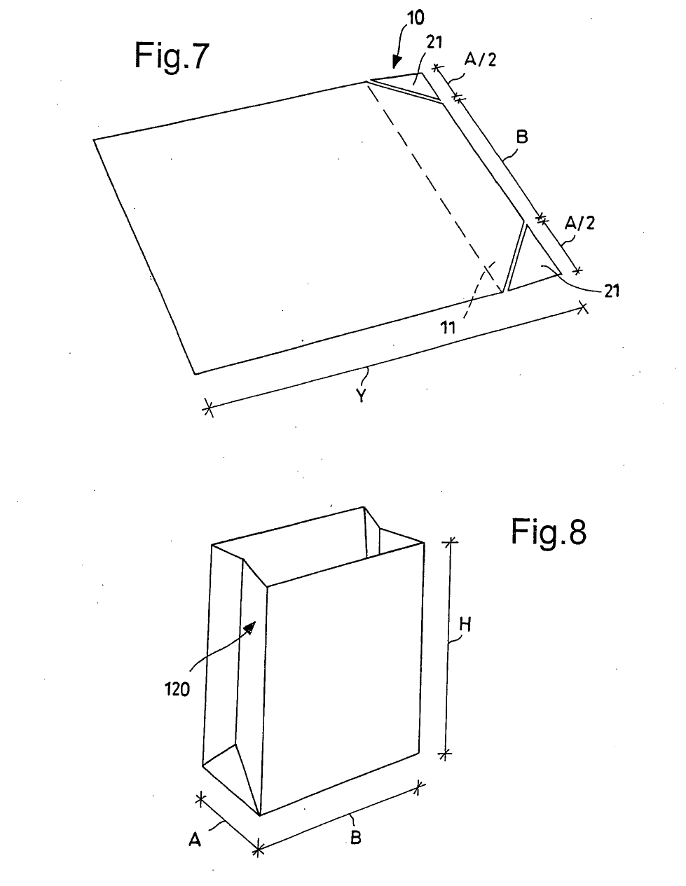

FIG. 7 is a schematic plan view of an additional step of an alternative embodiment of the method;

FIG. 8 shows a perspective view of a rectangular-bottomed bag made in a second embodiment according to the present invention.

With reference to the various figures, a method for producing rectangular or square-bottom bags, according to the present invention, is shown.

According to the present invention, it has been found that for making rectangular or square-bottomed bags it is necessary to start from a flat bag 10 with bottom bellows 11, as shown in FIG. 1.

This bag 10 is made with predetermined width X and height Y dimensions according to the final rectangular-bottomed bag that is wished to be obtained. In particular, according to the method of the present invention the width dimension of the base X is equal to the sum of the width B and the thickness A of a finished and open rectangular-bottomed bag 20, as illustrated in FIG. 6. The height Y is equal to the height H of the finished bag.

The initial flat bag 10 thus made is arranged on a supply plane 12 to be housed onto a forming group, schematically shown with 13 in FIG. 2.

The forming group 13 comprises a pair of flat plates 15a and 15b, a pair of side shaping plates for bellows 16a e 16b and a wedge 17 for shaping the base of the bag. The two flat plates 15a and 15b are placed overlapping each other and have a width dimension Z equal to the width B of the finished rectangular-bottomed bag 20 of FIG. 6.

Continuing the production method according to the present invention, FIG. 2 shows how the bag 10 is moved forwards according to the arrow K fitted onto the perfectly overlapped each other flat plates 15a and 15b of the forming group 13. This forming group 13 has the special feature of making a combined movement that allows the plates 15a and 15b to move away from one another according to the arrow T, ensuring that the bag 10 previously fitted takes up a parallelepiped or cube shape (according to the measurements A-B). At the same time, the plates 16a and 16b and the wedge 17 slide parallel with respect to the plates 15a and 15b and are arranged flush with the side walls P or outer sides of the bag thus defined and the wedge 17 shall be arranged flush with a back or base wall Q of the bag itself.

Once the aforementioned positions have been reached by all of the components of the forming group, the closure of the plates 15a and 15b will be carried out whereas the plates 16a and 16b advance towards each other according to the arrows U in contact with the walls P of the outer sides penetrating inside them so as to form bellows just as the wedge 17 will be inserted in the back wall or base wall Q of the bag C (FIG. 4).

This combined movement is thus necessary to ensure that the bag, once the plates 15a and 15b have been closed downwards or are pushed towards one another and the plates 16a and 16b and the wedge 17 are penetrated as far as they can go, forms inner folds or bellows, taking up its desired final shape.

As a further step, see FIG. 5, following prior withdrawal of the wedge 17 from the engagement inside the base of the bag, there will be the withdrawal of the bag itself through grasping elements or pincers (not shown) from the plates 15a and 15b.

The bag is thus formed as it is shown in FIG. 6, once open, that is to say with a square-shaped base, thanks to the inner folds or side and base “bellows” which open and stretch.

FIGS. 7 and 8 show a further embodiment of a rectangular or square-bottomed bag according to the invention, also with bottom bellows 11.

This bag is made with predetermined width X and height Y dimensions according to the final rectangular-bottomed bag that is wished to be obtained. In particular, in this embodiment two triangular portions 21 are removed from the base corners relative to parts of the bottom bellows 11 through wire welding means (not shown). Consequently, the width dimension of the base X is equal to the sum of the width B and of two thicknesses A/2 of a finished and open rectangular-bottomed bag 120, as illustrated in FIG. 7. The height Y, minus the size of the bottom bellows 11 is equal to the height H of the finished bag.

The initial flat bag 10 thus made therefore has as an additional initial step, that of being removed of the corners 21, before being arranged on the forming group 13 from which it undergoes the same forming steps as the bag previously described.

FIG. 8 shows the final shape of the bag 120. From the description made the characteristics of the method and of the device object of the present invention should be clear, as should the relative advantages also be clear.

Finally, it should be clear, that the method and the device thus conceived can undergo numerous modifications and variants, all covered by the invention; moreover, all the details can be replaced by technically equivalent elements. In practice the materials used, as well as the sizes, can be any according to the technical requirements.

1. Method for producing rectangular-bottomed bags comprising the following steps:
initially making a flat bag (10) with bottom bellows (11);
inserting said flat bag (10) onto a forming group (13) provided with means (15a, 15b) for widening out the bag (10) and making said widening means (15a, 15b) move apart so as to make said flat bag (10) take up a parallelepiped or cube shape;
inserting bellows shaping means (16a, 16b) onto the bag (10), deformed according to the previous step, on side walls or outer sides (P), and inserting a shaping wedge (17) onto the base, and at the same time making said widening means (15a, 15b) come together and inserting said wedge (17);
withdrawing said wedge (17) from said bag (10), once it has been flattened again and thus shaped;
withdrawing the bag (20) formed by said widening means (15a, 15b) of the bag (10).

2. Method according to claim 1, wherein said flat bag (10) with bottom bellows (11) foresees a width dimension of the base (X) equal to the sum of the width (B) and the thickness (A) of a finished and open rectangular-bottomed bag (20), whereas the height (Y, H) is the same between initial flat bag (10) and finished rectangular-bottomed bag (20).

3. Method according to claim 1, wherein said widening means (15a, 15b) of the bag (10) consist of flat plates that can be moved towards and away from one another.

4. Method according to claim 2, wherein said widening means (15a, 15b) of the bag (10) consist of flat plates that can be moved towards and away from one another.

5. Method according to claim 1, wherein said bellows shaping means (16a, 16b) consist of side shaping plates that can be moved towards and away from one another.

6. Method according to claim 2, wherein said bellows shaping means (16a, 16b) consist of side shaping plates that can be moved towards and away from one another.

7. Method according to claim 1, wherein said flat bag (10) with bottom bellows (11) foresees removal step of triangle portions (21) from bag corners at the bottom bellows (11).

8. Method according to claim 7, wherein said flat bag (10) with bottom bellows (11) foresees a width dimension of the base (X) equal to the sum of the width (B) and the thickness (A/2) for each triangle portion (21) removed from corners of a finished and open rectangular-bottomed bag (120), whereas the height (H) is equal to the height (Y) of initial flat bag (10) without the dimension of bellows (11).

9. Device for carrying out the method of claim 1, characterised in that it foresees means (15a, 15b) for widening out the bag (10) on a supply plane (12) of flat bags (10), suitable for receiving said bag (10), bellows shaping means (16a, 16b) in side walls of the bag (10) and a shaping wedge (17) of the bottom of said bag (10) placed at a bellows (11) able to be moved back and forth alternately.

10. Device according to claim 9, wherein means for withdrawing the bag formed by said widening means (15a, 15b) are also foreseen.

11. Device according to claim 9, wherein means are provided removal means of triangular portion (21) of a corner at said bottom bellows (11).
